(19) United States
(12) Patent Application Publication
(10) Pub. No.: US 2008/0208803 A1
(43) Pub. Date: Aug. 28, 2008

(54) SYSTEM AND METHOD FOR CHARACTERISING A WEB PAGE

(75) Inventors: Daniel Becher, Berlin (DE); Markus Baron, Berlin (DE)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: WAZAP AG, Berlin (DE)

(21) Appl. No.: 11/679,543

(22) Filed: Feb. 27, 2007

(51) Int. Cl. G06F 17/00

(52) U.S. Cl. 707/3; 707/E17.108

(57) ABSTRACT

The present invention relates to a method, computer system and computer program product for the characterising of web pages. The improved system and method for the characterising of web pages provides an improved search outcome for the user.

The present invention relates to a method, computer system and computer program product for the characterising of web pages. The improved system and method for the characterising of web pages provides an improved search outcome for the user.

### BACKGROUND OF THE INVENTION

The World Wide Web (WWW or “Web”) is a global collection of information resources accessible by using the “Internet”. The Internet is a collection of interconnected computer networks that provides access to the information resources of the Web. The information on the Web is organised into “web pages” and individual web pages related to the same topic or same organisation are often collected together as a “web site”.

A web “browser” is a computer program used to find and view information from the Web. Currently the Web information is normally presented in Hypertext Markup Language (HTML) format. Well known browsers include, for example, Microsoft Explorer, Mozilla Firefox and the Macintosh Safari browsers.

The information found using a browser is identified by a Uniform Resource Locators (URLs). The URLs can direct a user to either web site or to an individual web page. The URLs are normally of the form “http://somehost/somedirectory?parameters . . . ” where “somehost” is the hostname position of the URL and “somedirectory” is a directory in which the web page may be found. Although the URL of a web site can be relatively short and simple, the URL of a web page found within the site can be very lengthy and manually entering the URL accurately can be difficult.

This problem has been overcome by the ability of browsers to allow the user to “bookmark” a web page of interest and save it to the bookmark list of the user's Web browser. Once a bookmark is added to a bookmark list, in general, the bookmark becomes a permanent part of the Web browser until removed and offers a simple means of retrieving a desired web page. The user can simply select a bookmarked page from the bookmark list of the browser. Once a desired page is bookmarked the user does not need to enter a complex and lengthy URL to access the desired page, or navigate their way through a website from the relatively simple entry URL to the desired page. Identifying information about a bookmarked URL can also be associated with a bookmark and this information is commonly referred to a “tag”.

Information from the Web can be retrieved through web search pages. The web browser user inputs search terms into the web search pages and pages matching the search terms will be listed. This can lead to a very large number of matches (web sites or pages) being listed for a search term, and the web browser user must then manually access each listed web site or page to determine the relevance of the information contained therein.

Herein, we report the development of an improved method, computer system, and computer program product for characterising a web page by using input tag information data. A floating window interface is provided for recording tag information and the web page can be ranked by the Web browser according to the input tag information data.

Bookmarking of web pages, the use of floating windows and tracking the frequency of accessing a web page are all known in the prior art.

U.S. Pat. No. 6,924,827 B1 discloses a floating window that is always visible regardless of what other applications are in use. The floating window is used to save sections of text or graphic data copied from within web pages as a “gem data object” and user comments on the saved section can linked to the “gem data object”. A brief comment (tag) providing identifying information for the topic of the “gem data object” can also be saved.

U.S. Pat. No. 6,970,749 B1 discloses the use of floating windows that cover a portion of an active window to present control functions and/or control data for use in formatting an electronic document in the active window.

US 2002/0186239 A1 discloses a browser display including an importance degree control unit which stores the number of times of display of any Web page which has been accessed by an associated URL and automatically bookmarks the URL when the number of times of access exceeds a preset threshold value.

However the prior art does not disclose the inventive system and method for characterising a web page by using input tag information data wherein a floating window interface is provided for recording tag information and the web page can be ranked by the Web browser according to the input tag information data.

It is the object of the present invention to provide an improved system and method for characterising a web page that enables the user to input tag information for a web page. It is a further object of the present invention to provide an improved system and method for ranking a web page, wherein the web page is ranked according to the input tag information data.

The object of the present invention is solved by the teaching of the independent claims. Further advantageous features, aspects and details of the invention are evident from the dependent claims, the description, and the examples of the present application.

### DESCRIPTION OF THE INVENTION

The present invention provides a method of characterising search results based on a feedback cycle from a host server browser interface user to the host server. In brief, information data for a search result input by a host server browser interface user to an information data management program interface is saved by the host server to rank the search result. For example, the ranking can be generated according to the number of users that have input information data for a particular search result. This ranking is then available for use by the host server when providing a search result listing which could include the ranked search result. As a consequence the relevance of a search result listing provided to a user of the host server web browser is improved.

In one embodiment of the invention information data input by all previous users can be viewed by the current user.

In another embodiment of the present invention a floating window interface is used, on which the user can enter information data for a viewed search result.

In yet another embodiment of the present invention the action of inputting information data for a search result causes a bookmark management program to automatically create a bookmark for that search result. The bookmark can subsequently be accessed and managed via a bookmark management program interface.

In another embodiment of the present invention a tag information data management program interface and a bookmark management program interface are viewed in the same interface.

The following is one example of the operation of the inventive method and system of the present invention.

A user conducts a web search on a host server (e.g. wazap.com) through a browser interface and the retrieved search results are displayed in the browser interface. When the user views a search result the search result is viewed in the same or a new browser interface window and a separate information data management program interface (e.g. floating window) is also displayed.

The information data management program interface shows a list of input information data (e.g. tags), if any, which have been input by other users for this search result. The tag information data management program interface also shows a list of input tag information data, if any, which has been input for this search result by the current user. If the current user has existing tag information data recorded for the search result they can edit the existing tag information data or delete the existing tag information data. If the current user has no existing tag information data for the search result they can input new tag information data.

The updated information data is transferred to the host server (e.g. wazap.com) and used by the information data management program to assign a ranking to the search result. If the search result has an existing ranking, the existing ranking will be revised based on the newly input information data and a new ranking will be assigned. This ranking could be assigned according to the number of users that have input tag information data for the search result. The ranking could also be assigned according to the date on entry of the input tag information data for the search result. This ranking could also be assigned based on the user that input the information, e.g. a host server client user or a host server employee user. For example, information data input by a host server employee user could be given a higher importance in generating a ranking than information input by a host server client user.

In a subsequent search the new ranking assigned to the search results will be used to rank the relevance of the search result. Also in a subsequent search the newly input tag information data will be displayed in the tag information data management program interface.

In addition to the procedure described above for ranking search results, the present invention also provides a bookmark management system and method. The following is one example of the operation of the inventive system and method.

By the user action of inputting tag information data for a search result a bookmark for that search result is automatically created in the personal bookmark collection of the user. The bookmark is recorded according to the input tag information data. The input tag information data of the bookmark collection is used for searching the bookmark collection. A bookmark management interface (e.g. floating window) is used to search and edit the bookmarks. When a user wishes to view a web site or page a search term (e.g. keyword) is entered in the bookmark management interface and a listing of all bookmarks containing that term in the input tag information data will be displayed. In the same way a user can retrieve all relevant bookmarks to edit the input tag information data of existing bookmarks or to delete existing bookmarks.

The tag information data management program interface and the bookmark management program interface can have normal “window” properties, for example, the interface can be minimized, moved by “dragging” and can be closed.

As used herein a “host server browser interface” is defined as any interface which provides a browser interface between a user and a host server and allows the user to at least input information data and view search results. For example, the “host server browser interface” can be the computer interface of a host server client.

As used herein a “search result” is defined as a link to a web page or a web site provided by a host server in response to an input search term. A search term can comprise any combination of words, number, symbols and alphabet characters.

As used herein a “web page” is defined as any information having an associated URL and accessible via the Internet. A web page URL may be the same as a web site URL or may be different from a web site URL.

As used herein “accessing” a web page is defined as opening the web page to view the information contained therein.

As used herein “tag information data” is defined as any information input to tag information data management system. This information may be automatically generated upon the accessing of web page or it may be input by a user viewing the web page.

As used herein “characterising” a web page is defined as the recording of information about the web page based on input tag information data and the generating of a ranking for the web page.

As used herein “ranking” is defined as the assigning of a relative weighting to a web page in comparison to other web pages for the purposes of optimizing a search result listing. Possible features that would increase the ranking of a web page could be frequency of input tag information for that web page or the date of input tag information for that web page.

As used herein a “user” is defined as an individual making use of a browser interface and a host server browser. As used herein a “current user” is defined as an individual currently making use of the browser interface and host server browser and a “previous user” is defined as an individual that has previously made use of the host server browser. The “user”, “current user” or “previous user” can be a host server client or the “user” “current user” or “previous user” can be a host server employee.

As used herein a “host server employee” is defined as any individual employed by the host server or contracted by the host server or any individual that is provided with privileged access to the tag information data management program interface by the host server.

As used herein a “floating window” is defined as a program interface that is accessible by a user and remains in view overlaid on top of the corresponding search result.

As used herein a “bookmark” is defined as a link to an URL that is directly accessible by a user via a browser interface.

As used herein “classifying” a bookmark is defined as the recording of information about the bookmark in a form searchable by a user.

Thus the present invention is directed to a computer implemented method for characterising web pages accessed via the Internet by an associated URL, said method comprising the steps of accessing a web page via a host server browser interface, displaying in the browser interface a tag information data management program interface, inputting a tag information data for the accessed web page to the tag information data management program interface, and saving the recorded tag information for the accessed web page to the tag information data management program. Preferably the tag information data management program is provided on the host server.

The method can further comprise the step of ranking of said web page by the tag information data management program according to the tag information data input to the tag information data management program for said web page. For example, the web page can be ranked by the tag information data management program according to the frequency that a tag information data has been input to the tag information data management program for said web page or according to the date that a tag information data has been input to the tag information data management program or according to the user that input the information, e.g. a host server client user or a host server employee user.

In the inventive method said tag information data management interface displays all previous tag information data that has been input to the tag information data management program for said web page. This tag information can have been input to the tag information data management program by a previous user or by the current user. Further, the tag information data input to the tag information data management program for said web page by the current user can be edited by the current user and this edited tag information data is then saved to the tag information data management program.

Preferably the tag information data management interface of the present invention is a floating window. The floating window can be continuously in view in the browser interface, is movable to a desired position in the browser interface by the user, can be minimized in the browser interface by the user and can be closed in the browser interface by the user.

Preferably the input tag information data is a user input information. In the inventive method in response to a user input information a bookmark management program automatically creates a bookmark for a web page. The bookmark for the web page is classified by the bookmark management program according to the user input information.

The bookmark can be accessed via a bookmark management program interface and can be edited by the user via the bookmark management program interface.

The present invention is also directed to computer system for characterising a web page accessed via the Internet by an associated URL, said system comprising means for accessing a web page via a host server browser interface, means for displaying in the browser interface a tag information data management program interface, means for inputting a tag information data for the accessed web page to the tag information data management program interface, and means for saving the recorded tag information for the accessed web page to the tag information data management program. Preferably the tag information data management program is provided on the host server.

The computer system can further comprise means, provided by the tag information data management program, for ranking said web page according to the tag information data input to the tag information data management program for said web page. For example, means, provided by the tag information data management program, for ranking said web page is according to the frequency that a tag information data has been input to the tag information data management program for said web page or according to the date that a tag information data has been input to the tag information data management program or according to the user that input the information, e.g. a host server client user or a host server employee user.

In the inventive computer system said tag information data management interface displays all previous tag information data that has been input to the tag information data management program for said web page. This tag information can have been input to the tag information data management program by a previous user or by the current user. Further, the computer system comprises means for the current user to edit said tag information data input to the tag information data management program for said web page by the current user and means for saving said edited tag information data to the tag information data management program.

Preferably the tag information data management interface of the computer system is a floating window. The floating window can be continuously in view in the browser interface, is movable to a desired position in the browser interface by the user, can be minimized in the browser interface by the user and can be closed in the browser interface by the user.

Preferably the input tag information data is a user input information. The computer system further comprises a bookmark management program comprising means for creating a bookmark for said web page in response to said user input information. Preferably the bookmark management program comprises means for classifying the bookmark for said web page according to the user input information

Preferably the bookmark management program comprises a bookmark management program interface for accessing the bookmark further comprising means for the user to edit the bookmark via the bookmark management program interface.

The present invention is also directed to a computer program product in a computer readable medium for characterising a web page accessed via the Internet by an associated URL, said computer program product comprising means for accessing a web page via a host server browser interface, means for displaying in the browser interface a tag information data management program interface, means for inputting a tag information data for the accessed web page to the tag information data management program interface, and means for saving the recorded tag information for the accessed web page to the tag information data management program. Preferably the tag information data management program is provided on the host server.

The computer program product in a computer readable medium can further comprise means, provided by the tag information data management program, for ranking said web page according to the tag information data input to the tag information data management program for said web page. For example, means, provided by the tag information data management program, for ranking said web page is according to the frequency that a tag information data has been input to the tag information data management program for said web page or according to the date that a tag information data has been input to the tag information data management program or according to the user that input the information, e.g. a host server client user or a host server employee user.

In the inventive computer program product in a computer readable medium said tag information data management interface displays all previous tag information data that has been input to the tag information data management program for said web page. This tag information can have been input to the tag information data management program by a previous user or by the current user. Further, the computer program product in a computer readable medium comprises means for the current user to edit said tag information data input to the tag information data management program for said web page by the current user and means for saving said edited tag information data to the tag information data management program.

Preferably the tag information data management interface of the computer program product in a computer readable medium is a floating window. The floating window can be continuously in view in the browser interface, is movable to a desired position in the browser interface by the user, can be minimized in the browser interface by the user and can be closed in the browser interface by the user.

Preferably the input tag information data is a user input information. The computer program product in a computer readable medium further comprises a bookmark management program comprising means for creating a bookmark for said web page in response to said user input information. Preferably the bookmark management program comprises means for classifying the bookmark for said web page according to the user input information

Preferably the bookmark management program comprises a bookmark management program interface for accessing the bookmark further comprising means for the user to edit the bookmark via the bookmark management program interface.

1. A computer implemented method for characterising a web page accessed via the Internet by an associated URL, said method comprising the steps of:
accessing a web page via a host server browser interface,
displaying in the browser interface a tag information data management program interface,
inputting a tag information data for the accessed web page to the tag information data management program interface, and
saving the recorded tag information for the accessed web page to the tag information data management program.

2. The computer implemented method of claim 1, wherein said tag information data management program is provided on the host server.

3. The computer implemented method of claim 1, wherein said web page is ranked by the tag information data management program according to the tag information data input to the tag information data management program for said web page.

4. The computer implemented method of claim 1, wherein said tag information data management interface displays all previous tag information data that has been input to the tag information data management program for said web page.

5. The computer implemented method of claim 4, wherein said tag information data has been input to the tag information data management program for said web page by a previous user.

6. The computer implemented method of claim 4, wherein said tag information data has been input to the tag information data management program for said web page by a current user.

7. The computer implemented method of claim 6, wherein said tag information data input to the tag information data management program for said web page by the current user can be edited by the current user.

8. The computer implemented method of claim 6, wherein said edited tag information data is saved to the tag information data management program.

9. The computer implemented method of claim 1, wherein said tag information data management interface is a floating window.

10. The computer implemented method of claim 9, wherein said floating window is continuously in view in the browser interface.

11. The computer implemented method of claim 10, wherein said floating window can be moved to a desired position in the browser interface by the user.

12. The computer implemented method of claim 10, wherein said floating window can be minimized in the browser interface by the user.

13. The computer implemented method of claim 10, wherein said floating window can be closed in the browser interface by the user.

14. The computer implemented method of claim 1, wherein said tag information data is a user input information.

15. The computer implemented method of claim 14, wherein in response to said user input information a bookmark management program automatically creates a bookmark for said web page.

16. The computer implemented method of claim 15, wherein the bookmark for said web page is classified by the bookmark management program according to the user input information.

17. The computer implemented method of claim 15, wherein the bookmark is accessed via a bookmark management program interface.

18. The computer implemented method of claim 17, wherein the bookmark can be edited by the user via the bookmark management program interface.

19. A computer system for characterising a web page accessed via the Internet by an associated URL, said system comprising:
means for accessing a web page via a host server browser interface,
means for displaying in the browser interface a tag information data management program interface,
means for inputting a tag information data for the accessed web page to the tag information data management program interface, and
means for saving the recorded tag information for the accessed web page to the tag information data management program.

20. The computer system of claim 19, wherein said tag information data management program is provided on the host server.

21. The computer system of claim 19, further comprising means, provided by the tag information data management program, for ranking said web page according to the tag information data input to the tag information data management program for said web page.

22. The computer system of claim 19, wherein said tag information data management interface displays all previous tag information data that has been input to the tag information data management program for said web page.

23. The computer system of claim 22, wherein said tag information data has been input to the tag information data management program for said web page by a previous user.

24. The computer system of claim 22, wherein said tag information data has been input to the tag information data management program for said web page by a current user.

25. The computer system of claim 24, further comprising means for the current user to edit said tag information data input to the tag information data management program for said web page by the current user.

26. The computer system of claim 24, further comprising means for saving said edited tag information data to the tag information data management program.

27. The computer system of claim 19, wherein said tag information data management interface is a floating window.

28. The computer system of claim 27, wherein said floating window is continuously in view in the browser interface.

29. The computer system of claim 28, wherein said floating window can be moved to a desired position in the browser interface by the user.

30. The computer system of claim 28, wherein said floating window can be minimized in the browser interface by the user.

31. The computer system of claim 28, wherein said floating window can be closed in the browser interface by the user.

32. The computer system of claim 19, wherein said tag information data is a user input information.

33. The computer system of claim 32, further comprising a bookmark management program comprising means for creating a bookmark for said web page in response to said user input information.

34. The computer system of claim 33, wherein the bookmark management program comprises means for classifying the bookmark for said web page according to the user input information.

34. The computer system of claim 33, wherein the bookmark management program comprises a bookmark management program interface for accessing the bookmark.

36. The computer system of claim 35, further comprising means for the user to edit the bookmark via the bookmark management program interface.

37. A computer program product in a computer readable medium for characterising a web page accessed via the Internet by an associated URL, comprising:
means for accessing a web page via a host server browser interface,
means for displaying in the browser interface a tag information data management program interface,
means for inputting a tag information data for the accessed web page to the tag information data management program interface, and
means for saving the recorded tag information for the accessed web page to the tag information data management program.

38. The computer program product of claim 37, wherein said tag information data management program is provided on the host server.

39. The computer program product of claim 37, further comprising means, provided by the tag information data management program, for ranking said web page according to the tag information data input to the tag information data management program for said web page.

40. The computer program product of claim 37, wherein said tag information data management interface displays all previous tag information data that has been input to the tag information data management program for said web page.

41. The computer program product of claim 40, wherein said tag information data has been input to the tag information data management program for said web page by a previous user.

42. The computer program product of claim 40, wherein said tag information data has been input to the tag information data management program for said web page by a current user.

43. The computer program product of claim 42, further comprising means for the current user to edit said tag information data input to the tag information data management program for said web page by the current user.

44. The computer program product of claim 42, further comprising means for saving said edited tag information data to the tag information data management program.

45. The computer program product of claim 37, wherein said tag information data management interface is a floating window.

46. The computer program product of claim 45, wherein said floating window is continuously in view in the browser interface.

47. The computer program product of claim 46, wherein said floating window can be moved to a desired position in the browser interface by the user.

48. The computer program product of claim 46, wherein said floating window can be minimized in the browser interface by the user.

49. The computer program product of claim 46, wherein said floating window can be closed in the browser interface by the user.

50. The computer program product of claim 37, wherein said tag information data is a user input information.

51. The computer program product of claim 50, further comprising a bookmark management program comprising means for creating a bookmark for said web page in response to said user input information.

52. The computer program product of claim 51, wherein the bookmark management program comprises means for classifying the bookmark for said web page according to the user input information.

53. The computer program product of claim 51, wherein the bookmark management program comprises a bookmark management program interface for accessing the bookmark.

54. The computer program product of claim 53, further comprising means for the user to edit the bookmark via the bookmark management program interface.
